(19) United States
(12) Patent Application Publication
(10) Pub. No.: US 2018/0188096 A1
(43) Pub. Date: Jul. 5, 2018

(54) MEASURING DEVICE FOR VOLUME OF LIQUID IN CONTAINER THROUGH TEMPERATURE CORRECTION AND CONTAINER

(71) Applicant: SHENZHEN MOIKIT NETWORK TECHNOLOGY CO., LTD, Shenzhen (CN)

(72) Inventor: Xiaoliang Li, Shenzhen (CN)

(21) Appl. No.: 15/906,020

(22) Filed: Feb. 27, 2018

Related U.S. Application Data
(63) Continuation of application No. PCT/CN2015/088855, filed on Sep. 2, 2015.

(30) Foreign Application Priority Data
Aug. 28, 2015 (CN) 201520664708.7

(51) Int. Cl. G01F 22/02; G01J 5/08

(52) U.S. Cl. CPC G01F 22/02; G01J 5/0806

(57) ABSTRACT

The present disclosure discloses a device for measuring the volume of liquid in a container by temperature calibration and a container. The device comprises: a compression member, limiting devices, the limiting devices being able to be hermetically connected to a container to form a sealed space in the container and being able to compress gas in the sealed space, and the limiting devices ensuring a fixed and known movement distance of the compression member; a gas pressure sensor for detecting gas pressure values; and a temperature detection device. The measurement device can acquire the volume of liquid in the container to be detected, the temperature value, the sectional size and the displacement value. The present disclosure can eliminate the influence of temperature on the result of measurement and thus increase the accuracy of measurement of the volume of liquid in a container.

### TECHNICAL FIELD

The present disclosure relates to the field of intelligent devices, and in particular to a method for measuring the volume of liquid and also a container supporting measurement of the volume of liquid therein.

### BACKGROUND OF THE PRESENT INVENTION

As the source of life, water is essential to life. A correct water drinking mode is helpful for people to keep healthy. In past, people drinks water only depending upon their own feelings and cannot intuitively know their own water intake. With the development of people's health consciousness and the progress of technology, intelligent water fountains become popular with people. By such intelligent water fountains, people's water intake in a day can be accurately measured. Therefore, people's water intake can be rationally regulated. Meanwhile, the water intake data will become an important part of the big health data. However, for existing intelligent water fountains, a measurement device is generally provided on a container. This way has the following disadvantages: first, due to the requirements on water leakage prevention, heat preservation and the like, there are certain limitations to the structure (including shape, material, function or the like) of the container, so that the use of the measurement device in the container will further increase the design and manufacture difficulty of the container and the production cost; second, the measurement device is not universal and needs to be designed separately for each type of containers, so that the production cost is further increased; and third, the existing measurement device is generally a liquid level sensor which has low stability and is likely to result in a measurement error due to the inclination and shape of the container, and it is thus unable to meet the requirements on accurate measurement.

There is an existing device for detecting the volume of liquid in a container based on the change in gas pressure. This device can form a sealed space with a container. By changing the volume of the sealed space, the change in gas volume and the corresponding change in gas pressure are obtained, so that the volume of liquid can be measured. Therefore, the above problem can be solved well. However, the temperature variable is not taken into consideration in this method. When the liquid stored in the container is at a certain temperature, additional change in the gas pressure will occur, resulting in an error in the measurement result.

### SUMMARY OF THE PRESENT INVENTION

In order to overcome the deficiencies of the prior art, the present disclosure provides a device for measuring the volume of liquid in a container by temperature calibration. The device can eliminate the influence of temperature on the result of measurement and thus improve the accuracy of measurement of the volume of liquid in a container, and can effectively eliminate the influence of liquid sloshing on the result of measurement and thus have high measurement stability. This device can be used together with containers of different material, functions and volumes and is thus highly universal. This device is convenient to use and realizes the detection of water volume during the normal use without requiring any special operation.

The present disclosure provides a container supporting measurement of the volume of liquid therein.

To solve the technical problem, the present disclosure employs the following technical solutions.

A device for measuring the volume of liquid in a container by temperature calibration is provided, which is used for measuring the volume of liquid in a container, including:

a compression member having a fixed and known sectional size, limiting devices being provided on the compression member, the limiting devices being able to be hermetically connected to a container to form a sealed space in the container and being able to compress gas in the sealed space through its movement relative to the container, and the limiting devices ensuring a fixed and known movement distance of the compression member;

a gas pressure sensor for detecting gas pressure values in the sealed space before and after the compression of gas therein; and

a temperature detection device for detecting a temperature value of gas in the sealed space;

wherein:

the measurement device can acquire the volume of liquid in the container to be detected, based on the gas pressure values, the temperature value, the sectional size and the displacement value.

As a further improvement of the solution, there are at least two limiting devices which are located in a same horizontal plane and made of conducting material, and the gas pressure sensor begins to detect a gas pressure value in the sealed space when the at least two limiting devices are turned on.

As a further improvement of the solution, the limiting devices include at least one fixed member and an elastic member correspondingly provided below the fixed member; both the fixed member and the elastic member are made of conducting material; the elastic member can do elastic movement and thus have a first state where it is connected to the fixed member and a second state where it is disconnected from the fixed member; and, the gas pressure sensor begins to detect a gas pressure value in the sealed space when the elastic member is in the first state.

As a further improvement of the solution, the temperature detection device includes a heat conducting plate arranged on the compression member and a temperature sensor for detecting the temperature of the heat conducting plate, and the heat conducting plate can come into contact with gas in the space for heat conduction after the sealed space is formed by the compression member and the container.

As a further improvement of the solution, the heat conducting plate can be made of copper, silver or artificial diamond.

As a further improvement of the solution, the temperature detection device includes an infrared thermometer arranged on the compression member.

As a hurdler improvement of the solution, the device for measuring the volume of liquid in a container by temperature calibration includes a Fresnel lens for increasing a sensing area of the infrared thermometer.

As a further improvement of the solution, the Fresnel lens is integrated on a compression surface of the compression member.

A container supporting measurement of the volume of liquid therein is provided, including a container opening, with protrusions being provided around an inner wall of the container, wherein the container Hither includes the device for measuring the volume of liquid in a container by temperature calibration, and the measurement device forms a sealed space in the container through the protrusions.

A device for measuring the volume of liquid in a container by temperature calibration is provided, which is used for measuring the volume of liquid in a container, including:

threads, an angle sensor and a compression member, wherein the pitch of the threads and the sectional size of the compression member are definite and known, the compression member can be in threaded connection to a container to form a sealed space in the container, the compression member can compress gas in the sealed space through its rotation relative to the container, and the angle sensor detects an angle value of the rotation of the compression member;

a gas pressure sensor for detecting gas pressure values in the sealed space before and after the compression of gas therein; and

a temperature detection device for detecting a temperature value of gas in the sealed space;

wherein:

the measurement device can acquire the volume of liquid in the container to be detected, based on the gas pressure values, the temperature value, the sectional size, the pitch and the angle value.

As a further improvement of the solution, the temperature detection device includes a heat conducting plate arranged on the compression member and a temperature sensor for detecting the temperature of the heat conducting plate, and the heat conducting plate can come into contact with gas in the space for heat conduction after the sealed space is formed by the compression member and the container.

As a further improvement of the solution, the heat conducting plate can be made of copper, silver or artificial diamond.

As a further improvement of the solution, the temperature detection device includes an infrared thermometer arranged on the compression member.

As a further improvement of the solution, the device for measuring the volume of liquid in a container by temperature calibration includes a Fresnel lens for increasing a sensing area of the infrared thermometer.

As a further improvement of the solution, the Fresnel lens is integrated on a compression surface of the compression member.

A container supporting measurement of the volume of liquid therein is provided, including a container opening, with protrusions being provided around an inner wall of the container, wherein the container further includes the device for measuring the volume of liquid in a container by temperature calibration, and the measurement device is in threaded connection to the container opening through the threads and forms a sealed space in the container through the protrusions.

The present disclosure has the following beneficial effects.

The device for measuring the volume of liquid in a container by temperature calibration can eliminate the influence of temperature on the result of measurement and thus improve the accuracy of measurement of the volume of liquid in a container; can effectively eliminate the influence of liquid sloshing on the result of measurement and thus have high measurement stability. This device can be used together with containers of different materials, functions and volumes and is thus highly universal. This device is convenient to use and realizes the detection of water volume during the normal use without requiring any special operation.

### BRIEF DESCRIPTION OF THE DRAWINGS

The present disclosure will be further described below by embodiments with reference to accompanying drawings.

FIG. 1 is a schematic view of a first temperature detection device used in the present disclosure;

FIG. 2 is a schematic view of a second temperature detection device used in the present disclosure;

FIG. 3 is a schematic view of an embodiment of a static detection scheme according to the present disclosure;

FIG. 4 is a schematic view of a first embodiment of a container according to the present disclosure;

FIG. 5 is a schematic view of an embodiment of a dynamic detection scheme according to the present disclosure; and

FIG. 6 is a schematic view of a second embodiment of the container according to the present disclosure.

### DETAILED DESCRIPTION OF THE PRESENT INVENTION

The concepts, specific structures and technical effects of the present disclosure will be clearly and completely described below by embodiments with reference to the accompanying drawings in order to fay understand the objectives, solutions and effects of the present disclosure. It is to be noted that, the embodiments in the present application and the features in the embodiments can be combined if not conflicted.

It is to be noted that, unless otherwise specified, when a certain feature is regarded as being “fixed” or “connected” to another feature, this feature may be directly fixed or connected to the another feature, or may be indirectly fixed or connected to the another feature. In addition, the expressions, such as upper, lower, left and right, used in the present disclosure are merely provided with respect to the positional relationship between components in the disclosure.

In addition, unless otherwise defined, the technical and scientific terms used herein have meanings the same as the common meanings interpreted by those skilled in the art. The terms used herein are merely for describing the specific embodiments and not intended to limit the present disclosure. The term “and/or” used herein includes any combination of one or more of related listed items.

It is well known that the pressure of gas is inversely proportional to the volume of the gas. If a sealed space is formed in a container and gas in the sealed space is compressed, the gas pressure in this space will change correspondingly. Therefore, when the value of the compressed volume of gas, the change in gas pressure at the corresponding moment and the volume value of the container can be measured accurately, according to the following formula □:

V₁=P₁Vₓ/(P₁−P₀)

and formula □:

V₂=V−V₁

the volume of liquid in the container can be obtained, where V₁ is a volume value of gas in the container before compression, Vₓ is a value of the compressed volume of gas in the container, P₀ is a gas pressure value in the container before compression (it is the atmospheric pressure value in this solution), P₁ is a gas pressure value in the sealed space after compression, V₂ is a volume value of liquid in the container, and V is a volume value of the container. Among the above parameters, V and P₀ are known, so that it is only required to obtain P₁ and Vₓ. Based on this theory, the present disclosure discloses a device for measuring the volume of liquid in a container.

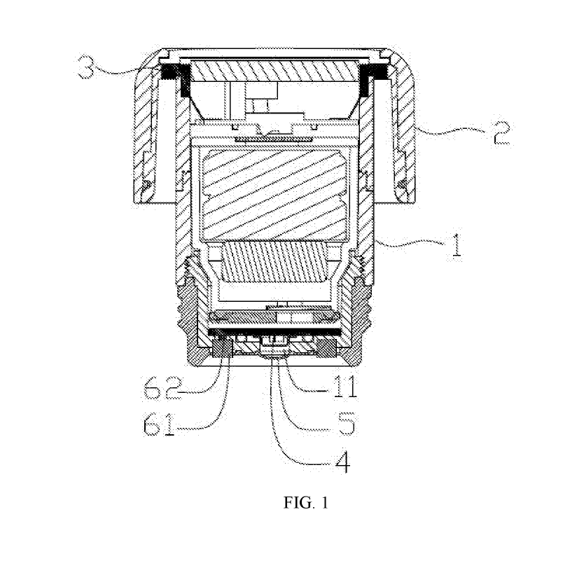

Referring to FIG. 1, the measurement device includes a compression member 1 having a fixed and known sectional size. A sealing ring and limiting devices 3 are provided on a periphery of the compression member 1. The compression member 1 is able to he hermetically connected to a container via a sealing ring to form a sealed space in the container and is able to compress gas in the space through its movement relative to the container. The limiting devices 3 can be resisted against the container after the compression member 1 moves for a certain distance, so as to limit the further movement of the compression member 1. This distance can be designed in advance or obtained by measurement, so that this distance is a definite constant. Since the sectional size and the movement distance of the compression member 1 are constants, the value Vₓ of the compressed volume of gas in the container (i.e., the value of invaded volume of the compression member 1) can be directly obtained by multiplying the sectional size by the movement distance. Additionally, a gas pressure sensor 4 for directly detecting the value of P1 is further provided. Accordingly, the P₁ and Vₓ are obtained. The volume of liquid can be obtained by the formulae □ and □. This is a static detection scheme.

Specifically, the limiting devices 3 are provided on the compression member 1. By using, as a starting point, the position where the sealing ring and the container realize a sealed relationship, the limiting devices 3 can allow the compression member to be pressed down for a certain distance relative to the container and then resisted against a container opening. This distance can be limited as a definite value by the structure.

Preferably, to prevent liquid or water vapor from damaging the sensor, a chamber 11 is formed on the compression member 1, and the gas pressure sensor 4 is mounted within the chamber. The chamber 11 isolates the gas pressure sensor 4 from the sealed space through a flexible member 5. Preferably, the chamber 11 is provided at an end of the compression member 1. Since the flexible member is located at a junction of the chamber 11 with the sealed space, when the gas pressure in the sealed space increases, the flexible member is pushed to sink towards the chamber 11, so that the volume of the chamber 11 decreases and the gas pressure in the chamber also increases. That is, the flexible member can transfer the change in pressure in the sealed space to the chamber. Furthermore, since a small stress is enough for the deformation of the flexible member, almost no energy loss occurs during the transfer process, and it can be considered that the gas pressure values on two sides of the flexible member are equal. Accordingly, the gas pressure sensor can detect the gas pressure value in the sealed space without being communicated with the sealed space, so that the corrosion from water vapor is avoided and the service life of the sensor is effectively prolonged.

Since the temperature variable is not taken into consideration in the above solution, an error may occur in the result of measurement of high-temperature liquid. In order to solve this problem, a temperature detection device is further provided in this solution. The temperature detection device can detect the temperature value of gas in the sealed space and calibrate the result of measurement by the temperature value. As a specific calibration method, first, the volume value of the sealed spaced is fixed (e.g., 100 ml), different temperature values are sampled from a common temperature interval (e.g., 40° C. to 100° C.) one by one, and gas pressure values in the sealed space at different temperatures are measured to obtain a set of data; and, the volume value of the sealed space is changed (e.g., to 95 ml), and the above process is repeated to obtain another set of data. A database containing all volumes, temperatures and gas pressures is obtained by multiple times of measurement in advance. Thus, after a gas pressure value and a temperature value are detected by the gas pressure sensor and the temperature sensor, a corresponding volume value can be derived inversely, and the calculated volume value can thus be corrected. In addition as a calibration method, calculation on the basis of an empirical formula is also possible.

As a specific implementation of the temperature detection device, the temperature detection device may be a combination of a heat conducting plate and a temperature sensor. The heat conducting plate 61 is arranged on a compression surface of the compression member 1 and hermetically connected to the compression surface of the compression member 1, so that the heat conducting heat 62 comes into contact with gas in the space for heat conduction after the sealed spaced is formed by the compression member 1 and the container. The temperature sensor 62 is used for measuring the temperature of the heat conducting plate 61. In this way, the heat of the liquid is gradually transferred to the heat conducting plate through the gas in the sealed space, and the temperature of the heat conducting plate tends to be consistent with the temperature of the liquid and is eventually detected by the temperature sensor.

Preferably, the heat conducting plate is made of copper, silver or artificial diamond having a high heat conductivity coefficient.

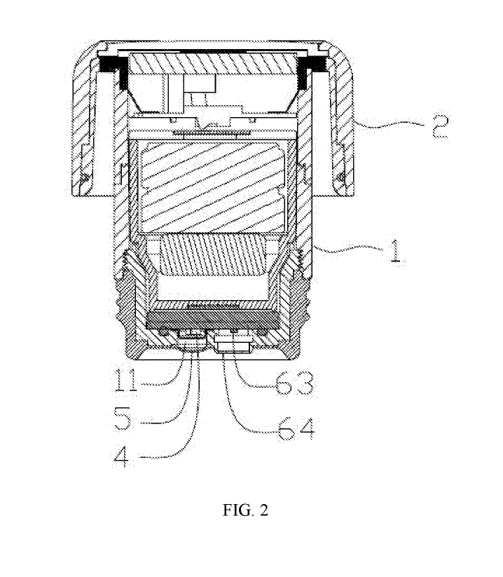

As another specific implementation of the temperature detection device, referring to FIG. 2, the temperature detection device may also be an infrared thermometer 63 by which real-time temperature measurement can be realized without any heat conduction process. Compared with the solution of using the heat conducting plate and the temperature sensor, this solution realizes quicker detection. Preferably, a Fresnel lens 64 for increasing a sensing area of the infrared thermometer is additionally provided. More preferably, to improve the sealing performance, the Fresnel lens 64 is integrated on the compression surface of the compression member 1.

For convenience of gripping, the measurement device further includes a lid 2, and the compression member 1 extends from an inner side face of the lid 2. When the measurement device is connected to the container, the compression member 1 is driven to do compression movement by the lid 2.

FIG. 1 shows an implementation of the limiting devices. There are at least two limiting devices 3 which are located in a same horizontal plane and made of conducting material. The gas pressure sensor 4 detects the gas pressure value in the sealed space when it is turned on between the limiting devices. This implementation is applicable to containers having a conducting function. When the container opening simultaneously comes into contact with the two limiting devices, the limiting devices are connected by the container, so that the gas pressure sensor is triggered to operate.

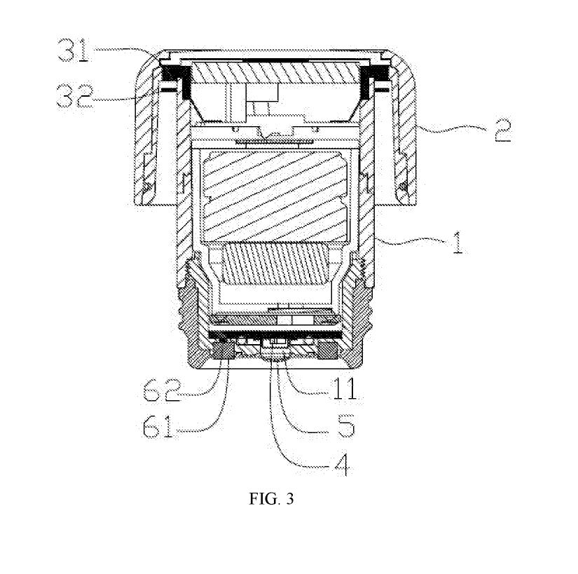

This embodiment is merely applicable to containers having a conducting function, but not to containers made of insulating material. In addition, due to the error, there may be a case in which the container cannot simultaneously come into contact with the two limiting devices so that the simultaneous measurement cannot be realized. Therefore, the present disclosure provides a further improvement. Referring to FIG. 3, the limiting devices include a fixed member 31 and an elastic member 2 correspondingly provided below the fixed member 31. The fixed member 31 and the elastic member 32 are made of conducting material. The elastic member 32 can do elastic movement and thus have a first state where it is connected to the fixed member 31 and a second state where it is disconnected from the fixed member 31. When the compressed member 1 is moved down for a certain distance, the container opening is resisted against the elastic member 32 to allow the elastic member 32 to come into contact with and be connected to the fixed member 31. This implementation is not limited to the material of the container, so that the problem in the above embodiment is effectively solved.

Similarly, the gas pressure sensor detects the gas pressure value in the sealed space when the elastic member is in the first state.

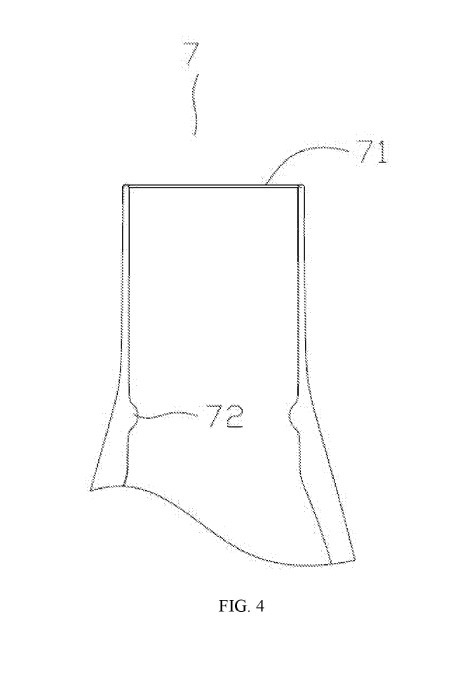

The present disclosure discloses a container using the static detection scheme. Referring to FIG. 4, the container 7 has a container opening 71. The measurement device is buckled on the container opening 71 through the lid. The compression member 1 extends into the container 7 to form a sealed space. By pressing down or rotating the lid, the compression member 1 can be driven to further extend into the sealed space so as to compress gas in the sealed space. Preferably, protrusions 72 are provided around an inner wall of the container 7. During the extension of the compression member 1 into the container, the sealing ring deforms when being squeezed by the protrusions 72, so that the better sealing effect can be realized and the compression starting point can be positioned more accurately.

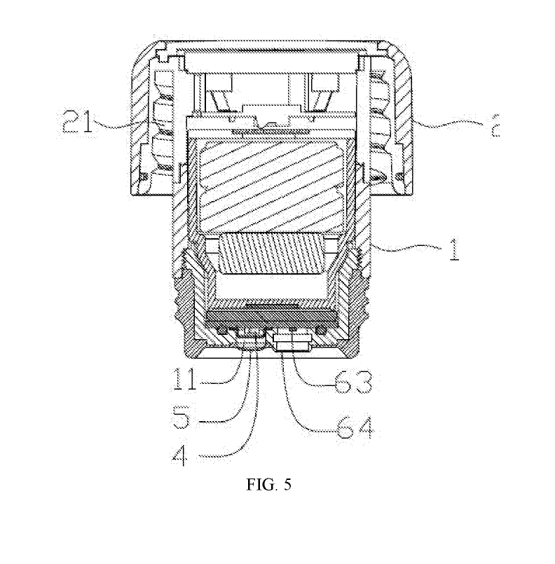

The present disclosure further provides a dynamic detection scheme different from the static detection scheme. Similarly, there are also a compression member and a gas pressure sensor. A difference between the static detection scheme and the dynamic detection scheme lies in that, the value Vₓ of the compressed volume of gas is detected in real time instead of being input in advance. Referring to FIG. 5, the measurement device further includes an angle sensor (not shown) and threads 21 arranged on the lid 2. The pitch of the threads is fixed and known. The measurement device is in threaded connection to a container through the threads and can be rotated in or out relative to the container. The angle sensor can acquire an angle value of the rotation of the lid, and a movement distance of the compression member can be dynamically detected in combination with the angle value and the pitch, so that the value of the compressed volume of gas is further determined.

It can be understood that the static detection scheme and the dynamic detection scheme are not independent absolutely and can be jointly used to achieve the optimal measurement effect.

The measurement device of the present disclosure may be further provided with an output terminal which can output the volume data of liquid in the form of voice, text or image.

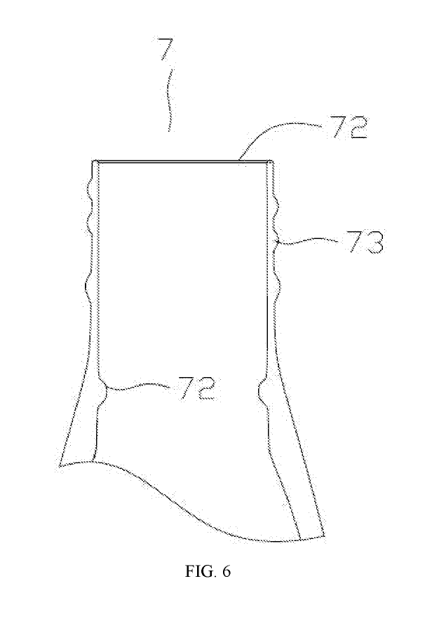

Referring to FIG. 6, the present disclosure discloses a container using the dynamic detection scheme. The container 7 has a container opening 71 with external threads 73. The measurement device is in threaded connection to the container opening 71 through the lid 2. The compression member 1 extends into the container 7 to form a sealed space. By rotating the lid, the compression member 1 can be driven to further extend into the sealed space so as to compress gas in the sealed space. Preferably, protrusions 72 are provided around an inner wall of the container 7. During the extension of the compression member 1 into the container, the sealing ring deforms when being squeezed by the protrusions 72, so that the better sealing effect can be realized and the compression starting point can be positioned more accurately.

Although the preferred embodiments of the present disclosure have been specifically described above, the present disclosure is not limited thereto. Those skilled in the art can make various equivalent variations or replacements without departing from the spirit of the present disclosure, and these equivalent variations or replacements shall fall into the scope defined by the appended claims of the present disclosure.

What is claimed is:

1. A device for measuring the volume of liquid in a container by temperature calibration, which is used for measuring the volume of liquid in a container, comprising:
a compression member having a fixed and known sectional size, limiting devices being provided on the compression member, the limiting devices being able to be hermetically connected to a container to form a sealed space in the container and being able to compress gas in the sealed space through its movement relative to the container, and the limiting devices ensuring a fixed and known movement distance of the compression member;
a gas pressure sensor for detecting gas pressure values in the sealed space before and after the compression of gas therein; and
a temperature detection device for detecting a temperature value of gas in the sealed space;
wherein:
the measurement device can acquire the volume of liquid in the container to be detected, based on the gas pressure values, the temperature value, the sectional size and the displacement value.

2. The device for measuring the volume of liquid in a container by temperature calibration according to claim 1, wherein there are at least two limiting devices which are located in a same horizontal plane and made of conducting material, and the gas pressure sensor begins to detect a gas pressure value in the sealed space when the at least two limiting devices are turned on.

3. The device for measuring the volume of liquid in a container by temperature calibration according to claim 1, wherein the limiting devices comprise at least one fixed member and an elastic member correspondingly provided below the fixed member; both the fixed member and the elastic member are made of conducting material; the elastic member can do elastic movement and thus have a first state where it is connected to the fixed member and a second state where it is disconnected from the fixed member; and, the gas pressure sensor begins to detect a gas pressure value in the sealed space when the elastic member is in the first state.

4. The device for measuring the volume of liquid in a container by temperature calibration according to claim 1, wherein the temperature detection device comprises a heat conducting plate arranged on the compression member and a temperature sensor for detecting the temperature of the heat conducting plate, and the heat conducting plate can come into contact with gas in the space for heat conduction after the sealed space is formed by the compression member and the container.

5. The device for measuring the volume of liquid in a container by temperature calibration according to claim 4, wherein the heat conducting plate can be made of copper, silver or artificial diamond.

6. The device for measuring the volume of liquid in a container by temperature calibration according to claim 1, wherein the temperature detection device comprises an infrared thermometer arranged on the compression member.

7. The device for measuring the volume of liquid in a container by temperature calibration according to claim 6, comprising a Fresnel lens for increasing a sensing area of the infrared thermometer.

8. The device for measuring the volume of liquid in a container by temperature calibration according to claim 7, wherein the Fresnel lens is integrated on a compression surface of the compression member.

9. A container supporting measurement of the volume of liquid therein, comprising a container opening, with protrusions being provided around an inner wall of the container, wherein the container further comprises the device for measuring the volume of liquid in a container by temperature calibration according to claim 1, and the measurement device forms a sealed space in the container through the protrusions.

10. A device for measuring the volume of liquid in a container by temperature calibration, which is used for measuring the volume of liquid in a container, comprising:
threads, an angle sensor and a compression member, wherein the pitch of the threads and the sectional size of the compression member are definite and known, the compression member can be in threaded connection to a container to form a sealed space in the container, the compression member can compress gas in the sealed space through its rotation relative to the container, and the angle sensor detects an angle value of the rotation of the compression member;
a gas pressure sensor for detecting gas pressure values in the sealed space before and after the compression of gas therein; and
a temperature detection device for detecting a temperature value of gas in the sealed space;
wherein:
the measurement device can acquire the volume of liquid in the container to be detected, based on the gas pressure values, the temperature value, the sectional size, the pitch and the angle value.

11. The device for measuring the volume of liquid in a container by temperature calibration according to claim 10, wherein the temperature detection device comprises a heat conducting plate arranged on the compression member and a temperature sensor for detecting the temperature of the heat conducting plate, and the heat conducting plate can come into contact with gas in the space for heat conduction after the sealed space is formed by the compression member and the container.

12. The device for measuring the volume of liquid in a container by temperature calibration according to claim 11, wherein the heat conducting plate can be made of copper, silver or artificial diamond.

13. The device for measuring the volume of liquid in a container by temperature calibration according to claim 10, wherein the temperature detection device comprises an infrared thermometer arranged on the compression member.

14. The device for measuring the volume of liquid in a container by temperature calibration according to claim 13, comprising a Fresnel lens for increasing a sensing area of the infrared thermometer.

15. The device for measuring the volume of liquid in a container by temperature calibration according to claim 14, wherein the Fresnel lens is integrated on a compression surface of the compression member.

16. A container supporting measurement of the volume of liquid therein, comprising a container opening, with protrusions being provided around an inner wall of the container, wherein the container further comprises the device for measuring the volume of liquid in a container by temperature calibration according to claim 10, and the measurement device is in threaded connection to the container opening through the threads and forms a sealed space in the container through the protrusions.
